(19) United States
(12) Patent Application Publication
(10) Pub. No.: US 2017/0329021 A1
(43) Pub. Date: Nov. 16, 2017

(54) SYSTEM AND METHOD FOR COMBINING DETECTOR SIGNALS

(71) Applicant: General Electric Company, Schenectady, NY (US)

(72) Inventor: Chad Jacob BIRCHER, Niskayuna, NY (US)

(21) Appl. No.: 15/152,607

(22) Filed: May 12, 2016

(51) Int. Cl. G01T 1/208; G01T 1/20

(52) U.S. Cl. CPC G01T 1/208; G01T 1/2018

(57) ABSTRACT

Provided are a system and method for combining detector signals. In one exemplary embodiment, the system includes the detector, a plurality of ASICs where each ASIC may receive an electric signal from the detector and generate a position signal and an energy signal based on the received electric signal, a combiner that may combine a position signal output from a first ASIC and a position signal output from a second ASIC to generate a combined position signal, and combine an energy signal output from the first ASIC and an energy signal output from the second ASIC to generate a combined energy signal, and an analog-to-digital converter that may receive the combined position signal and the combined energy signal and generate digitized image data for the first ASIC and the second ASIC based thereon.

### FIELD

Exemplary embodiments described herein relate generally to detectors such as those that may be used in diagnostic and biomedical imaging systems, and more particularly, to a detector that requires less channels for processing signals.

### BACKGROUND

Diagnostic medical imaging, also referred to as nuclear medical imaging, captures images of a patient and uses them to determine information about a function and an integrity of the patient's internal structures such as organs, muscles, tissue, and the like. The images may be used to detect tumors, metastases, and other abnormalities, within a patient, and for clinical diagnosis of diseases. Diagnostic imaging is also an important tool for researching brain and heart function, as well as supporting drug development. A typical diagnostic imaging system operates based on various physical principles, including the emission and/or transmission of radiation from tissue of the patient allowing for images of interior regions of the patient to be constructed through a non-invasive procedure. In addition, attenuation information may be obtained at various angular displacements to generate depth information coincident with the attenuation information.

Examples of diagnostic medical imaging technologies include single photon emission computed tomography (SPECT), positron emission tomography (PET), and the like, which may utilize a radiopharmaceutical that is administered to a patient and that breaks down in the body of the patient resulting in an emission of gamma rays from locations within the patient's body. The radiopharmaceutical is typically selected so that it is preferentially and/or differentially distributed in the body based on physiological or biochemical processes in the body. For example, a radiopharmaceutical may be selected that is preferentially processed or attracted to or otherwise consumed by tumor tissue. In such an example, the radiopharmaceutical will typically appear in greater concentrations around the tumor tissue in comparison to surrounding areas within the patient.

In PET imaging, the radiopharmaceutical breaks down or decays within the patient, releasing a positron which annihilates when encountering an electron and which produces a pair of gamma rays moving in opposite directions as a result of the process. In SPECT imaging, a single gamma ray may be generated when the radiopharmaceutical breaks down or decays within the patient. These gamma rays interact with detection mechanisms within the respective PET or SPECT scanner, which allow the decay events to be localized, thereby providing a view of where the radiopharmaceutical is distributed throughout the patient. As a result, a caregiver or a medical professional can visualize where within the patient the radiopharmaceutical is disproportionately distributed and thereby identify a location at which physiological structures and/or biochemical processes of diagnostic significance are located.

In these exemplary imaging technologies, a detector is used to convert incident radiation into electrical signals which can be used to generate the images of the patient. Recent detector technologies include a silicon photomultiplier (SiPM), which includes a number of microcells that are useful for detecting optical signals generated in a scintillator when radiation is incident on the scintillator. However, the cost of detectors using SiPMs can be expensive. A large reason for the expense of SiPM detectors is caused by the circuity and electronics disposed after the SiPM within the system. Accordingly, there is a desire to reduce the number of electronic channels within the system and reduce overall cost without degrading performance.

### BRIEF DESCRIPTION OF THE DRAWINGS

Features and advantages of the exemplary embodiments, and the manner in which the same are accomplished, will become more readily apparent with reference to the following detailed description taken in conjunction with the accompanying drawings, in which:

FIG. 1 is a diagram illustrating a medical imaging apparatus in accordance with an exemplary embodiment.

FIG. 2 is a diagram illustrating application specific integrated circuit (ASIC) output channels of an imaging apparatus, in accordance with an exemplary embodiment.

FIG. 3 is diagram illustrating ASIC output channels of an imaging apparatus, in accordance with another exemplary embodiment.

FIGS. 4A and 4B are diagrams illustrating examples of detector positions of the imaging apparatus created by the ASIC output channels of FIGS. 2 and 3, respectively, in accordance with exemplary embodiments.

FIG. 5 is a diagram illustrating a medical imaging method in accordance with an exemplary embodiment.

FIG. 6 is a diagram illustrating an example of encoding ASIC output signals in accordance with an exemplary embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various exemplary embodiments. It should be appreciated that various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The exemplary embodiments described herein relate to post ASIC multiplexing performed in a medical imaging apparatus. According to various exemplary embodiments, ASIC output signals are combined prior to being converted from analog to a digital signals, thus reducing the number of electronic channels needed or used for digitization. For example, ASIC output signals (X, Y, and E) from two ASICS may be combined, respectively, and a timing signal (T) may be combined so that three analog-to-digital converters and one time-to-digital converter can process two complete ASIC output sets rather than a single ASIC output set. The ASIC output signals may be combined and an overall number of analog-to-digital converters and time-to-digital converters can be reduced thus reducing the overall cost of the imaging apparatus.

The cost of an imaging system using silicon photomultiplier (SiPM) detectors is largely driven by circuity included in the system at a position after the application specific integrated circuits (ASICs). Therefore, there is a desire to reduce the number of electronics channels without degrading the performance of the system. An ideal detector would have a small area of SiPM per timing channel (good timing resolution), small SiPM pixel size (good crystal separation), small BGO crystals (good spatial resolution), a small paralyzable area (good count rate performance), and few electronics channels (low cost). The SiPMs used in more recent PET detectors require specialized electronics for processing. One such processing approach is the PSYCHE ASIC which can multiplex up to 18 SiPM signals and generate four signals, three analog signals (two for position and one for energy) and one signal for timing. Due to the cost of the post-processing electronics it would be advantageous to reduce the number of SiPMs per processing channels from 18:4 to 24:4 or higher. However, increasing the amount of SiPMs per ASIC may cause significant problems due to increased noise in the timing signal.

As described herein, the output of two or more ASIC banks may be summed together before entering into a digitizer in order to increase the paralyzable area of the detector. The energy signal from two ASICs may be combined and the respective position signals from two ASICs may be combined, for example, using a summing amplifier, multiplexor, a simple circuit, and the like. In addition, the timing signals may be combined using an OR gate, and the like. In these examples, ASIC output signals can be summed so that a single set of three analog-to-digital converters (ADCs) and one time-to-digital converter (TDC) can process two complete ASIC banks rather than one bank.

According to various aspects, ASIC weights may be adjusted in each bank so that only half of a range of X or Y is used. In these examples, X and Y may represent arbitrary axis locations such as X-axis and Y-axis locations corresponding to a detector. That is, the X position and the Y position may be used to indicate a two-dimensional position on the detector and are not meant to be limited to specific direction or axis. Meanwhile, E may be used to indicate an amount of energy that is detected at a particular location. As a non-limiting example, a detector may include four crystals from a scintillator that are encoded across two SiPMs using ASIC weights of 0 and 10 on the two SiPMs. As another example, the full ASIC weight range may be between 0 and 15. In an example in which two banks are set with location weights (X or Y) of 0, 1, 5, and 15, the crystal separation should be identical to what it is in a related art and the output signals may be directly summed. As another example, if the overlap between blocks is sufficient the crystals may still be decoded with values of 0, 8, 7, and 15 and the separation would be more than sufficient. The number of SiPMs per ASIC timing channel may remain the same.

The exemplary embodiments may be implemented with existing detector designs allowing a fast product development. Furthermore, the exemplary embodiments reduce the number of digitization channels in half compared to the related art. The exemplary embodiments may allow for a direct porting of a detector block without requiring a redesign of the light guide or crystal pack. The paralyzable area may be less than that of the current detector improving the count rate capability. Furthermore, the design according to various exemplary embodiments may also be scalable and if larger blocks are used it can be adapted to larger areas without a decrease in timing, energy, or positioning performance.

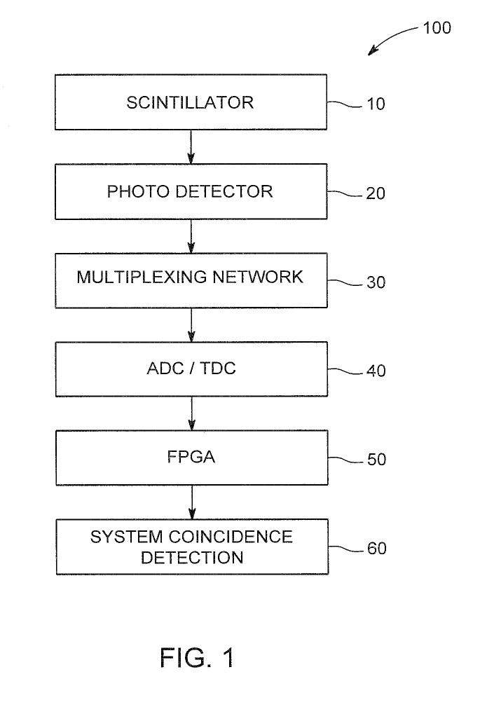

FIG. 1 illustrates a conceptual diagram of a medical imaging apparatus 100 in accordance with an exemplary embodiment. Referring to FIG. 1, imaging apparatus 100 includes a scintillator 10, a photodetector 20, a multiplexing network 30, conversion circuitry (ADC and TDC) 40, a floating point gate array (FPGA) 50, and a system coincidence detection 60. It should also be appreciated that the imaging apparatus 100 may include other features that are not shown or described in the example of FIG. 1. The imaging apparatus 100 may be a diagnostic imaging apparatus or nuclear imaging apparatus and may be based on single photon emission computed tomography (SPECT), positron emission tomography (PET), and the like.

The scintillator 10 may be optically coupled to the photodetector 20. Here, the scintillator 10 may correspond to a scintillation array including a plurality of scintillators 10. Gamma rays that are emitted from, for example, a patient may be detected by and grouped together by the scintillator 10. In response, the scintillator 10 may convert the gamma rays into an optical burst (i.e., photons) which may be passed to the photodetector 20. The photodetector 20 may convert photons received from the scintillator 10 into electrons or into an electronic signal. In addition, the photodetector 20 may amplify the electronic signal received from the scintillator 10. It should also be appreciated that the photodetector 20 may correspond to an array of photodetectors 20. Furthermore, as a non-limiting example, the photodetector 20 may include one or more SiPMs, avalanche photodiodes (APDs), photomultiplier tubes (PMTs), and the like. In one example, the imaging apparatus 100 may include a few photodetectors 20 to read out a larger number of scintillators 10. Also, each photodetector 20 may have its own individual output.

An ASIC may be coupled or electronically connected to a photodetector 20 for processing the electronic signal generated by the photodetector 20. For example, an ASIC may convert an electronic signal from the photodetector 20 into an X position signal, a Y position signal, an energy signal, and a timing signal. As a result, the ASIC may have four outputs including two outputs for location (X and Y), one output for energy, and one output for timing. A typical medical imaging system has too many detectors to feasibly digitize every detector individually. According to various exemplary embodiments, the multiplexing network 30 reduces the number of electronics channels before digitization. The multiplexing network 30 may include summing circuitry, for example, one or more of summing amplifiers, summing circuits, multiplexors, and the like. The imaging apparatus 100 may further include a number of digitizers such as analog-to-digital converters (ADCs) and time-to-digital converters (TDCs) 40, which receive the combined signals from the multiplexing network 30.

Accordingly, a position signal output from a first ASIC may be combined with a position signal output from a second ASIC by the multiplexing network 30, and a single combined position signal representing the first and second ASIC may be output from the multiplexing network 30 and input to an ADC 40. For example, an X position signal output from the first ASIC may be combined with an X position signal output from the second ASIC, and a single combined X position signal may be generated by the multiplexing network 30 and output as an X position signal of the first and second ASIC. As another example, an energy signal output from a first ASIC may be combined with an energy signal output from a second ASIC, and a single combined energy signal may be generated by the multiplexing network 30 and output as a combined energy signal corresponding to the first and second ASIC. In these examples, X position signals from two ASICs may be combined such that the X position signals from the two ASICs are simultaneously received by the ADC. Also, Y position signals and energy signals from the two ASICs may be combined respectively such that Y position signals from the two ASICs are simultaneously received by an ADC and energy signals from the two ASICs are simultaneously received.

In the exemplary detector apparatus described herein, a relatively small number of digitizers may be used to digitize signals detected by a larger number of scintillators 10 and received from the multiplexing network 30. The ADCs/TDCs 40 may be passed to the FPGA 50 for further processing. The FPGA 50 may look for valid events within a group of detectors. System coincidence detection 60 may receive the processed signal from the FPGA 50. For example, if two different FPGAs detect events within a short time frame the system coincidence detection 60 may record the pair of events.

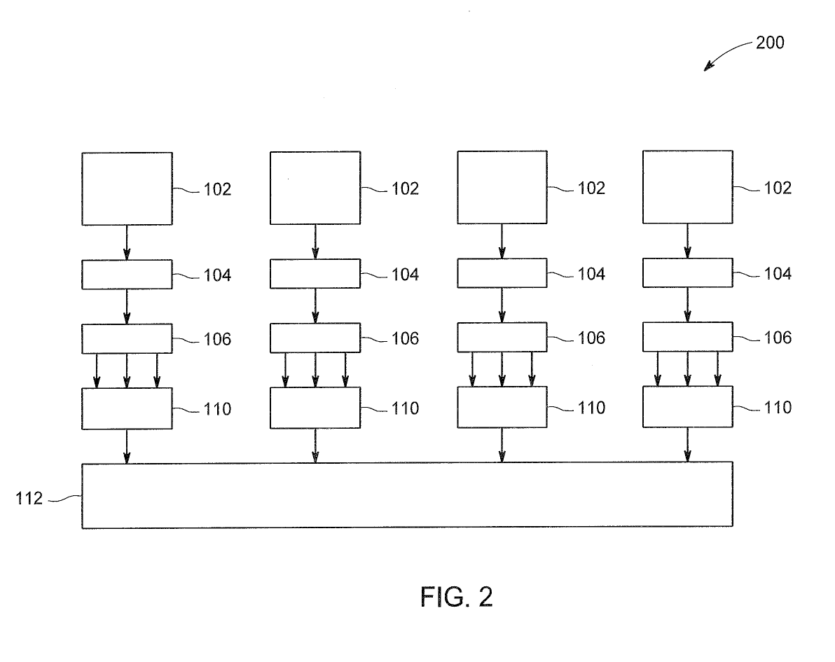

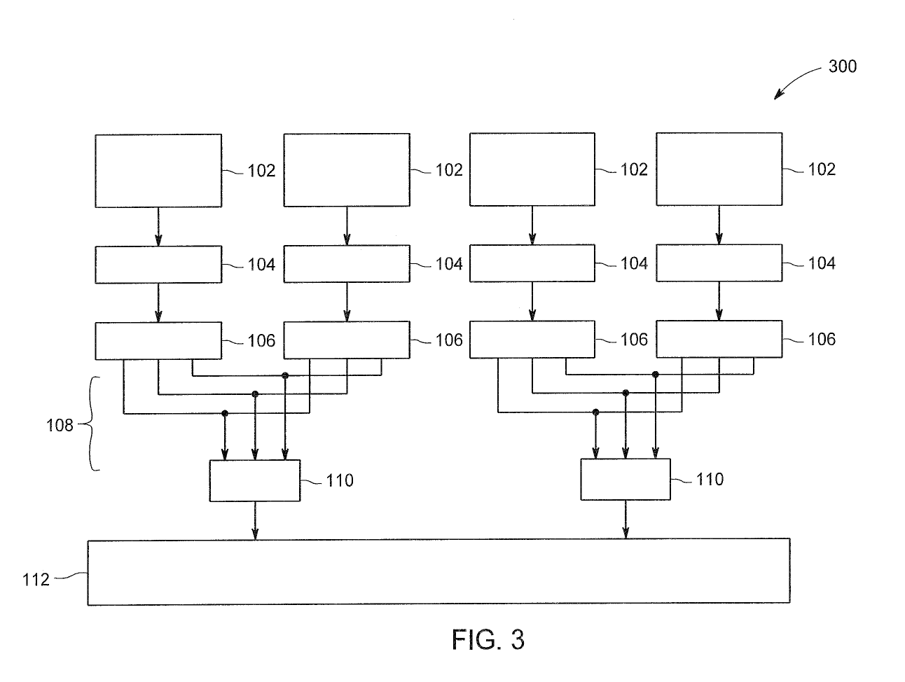

FIG. 2 illustrates output channels of application specific integrated circuits (ASICs) of the imaging apparatus 200 in accordance with an exemplary embodiment and FIG. 3 illustrates output channels of ASICs of the imaging apparatus 300 in accordance with another exemplary embodiment. Referring to FIGS. 2 and 3, a scintillator array is provided including a plurality of scintillators 102. Each scintillator 102 may exhibit scintillation when excited by ionizing radiation received from, for example, a patient. A plurality of SiPMs 104 (i.e., photodetectors) are coupled to the scintillators 102 included in the scintillation array. Each of the SiPMs 104 may convert photons received from a scintillator 102 into an electronic signal. An ASIC 106 is coupled to each respective SiPM 104 and receives an electronic signal generated by the SiPM 104 and generates position signals, an energy signal, and a timing signal corresponding to detection.

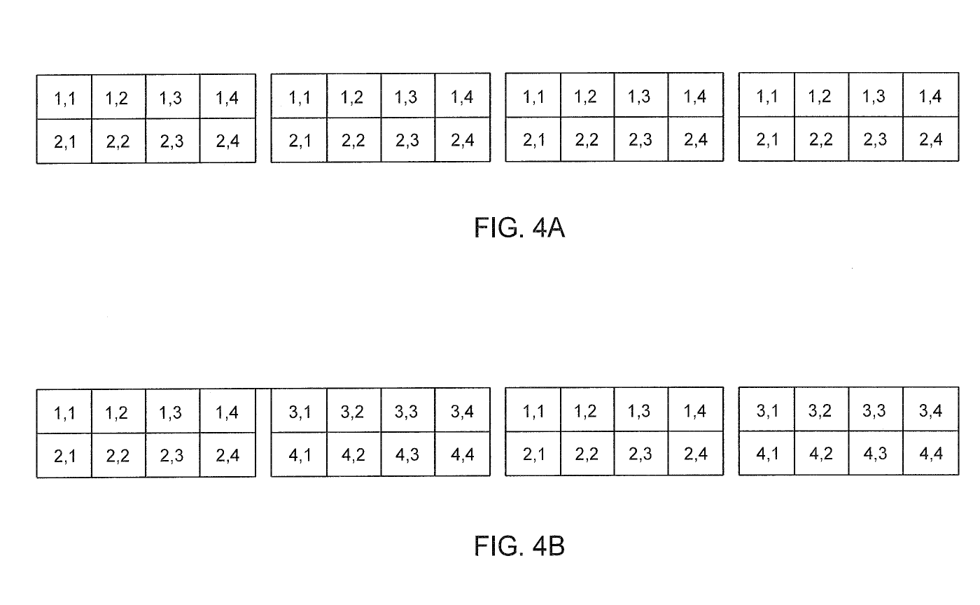

In the example of FIG. 2, outputs (X, Y, and E) from each ASIC 106 are input to a respective set of three (3) ADCs represented by block 110 and the timing output may be input to a TDC (not shown). In this example, each of the X, Y, and E outputs 106 is input to its own respective ADC 110 for conversion from an analog signal to a digital imaging signal. An example of detector positions of the imaging apparatus 200 of FIG. 2 are shown in FIG. 4A. In the example of FIG. 4A, X and Y are weighted separately and each unit is independent.

However, the imaging system 200 may have too many detectors 104 to feasibly digitize electronic signals from each detector 104 individually because doing so can be expensive. Accordingly, in the imaging apparatus 300 of FIG. 3, outputs of a first ASIC 106A are combined with outputs from a second ASIC 106B by combiner 108. For example, the combiner 108 may include one or more of a summing amplifier, a multiplexor, a summing circuit, and the like. In FIG. 3, an X position signal output from ASIC 106A and an X position signal output from ASIC 106B are input to combiner 108. Here, the combiner 108 combines the X position signal from ASIC 106A with the X position signal from ASIC 106B to generate a combined X position signal. Likewise, a Y position signal output from ASIC 106A and a Y position signal output from ASIC 106B are input to combiner 108 and combiner 108 combines the Y position signal from ASIC 106A with the Y position signal from ASIC 106B to generate a combined Y position signal. Furthermore, an energy signal output from ASIC 106A and an energy signal output from ASIC 106B are input to combiner 108 and combiner 108 combines the energy signal from ASIC 106A with the energy signal from ASIC 106B to generate a combined energy signal. The combined X position signal may be input to an ADC 110, the combined Y position signal may be input to another ADC 110, and the combined energy signal may also be input to another ADC 110. An example of detector positions of the imaging apparatus 300 of FIG. 3 are shown in FIG. 4B. In the example of FIG. 4A, X and Y are weighted separately, however, each unit is interdependent.

In the example of FIG. 3, imaging apparatus 300 includes a plurality of ASICs 106 that are each configured to receive an electronic signal from a detector 104 and generate at least one position signal (such as two position signals for each of X and Y) and an energy signal based on the received electric signal. Also, combiner 108 is configured to combine a position signal output from a first ASIC 106A and a position signal output from a second ASIC 106B to generate a combined position signal, and combine an energy signal output from the first ASIC 106A and an energy signal output from the second ASIC 106B to generate a combined energy signal. Imaging apparatus 300 also includes a plurality of ADCs 110 including at least one ADC 110 configured to receive a combined position signal (e.g., X or Y) and a second ADC 110 configured to receive the combined energy signal, and generate digitized image data for the first ASIC and the second ASIC based on the combined position signal and the combined energy signal and transmit the image data to the FPGA 112.

In the example of FIG. 3, the first and second ASICs 106A and 106B may be configured such that a value of the position signal generated by and output from the first ASIC 106A has a value that does not overlap a value of the position signal generated by and output from the second ASIC 106B. For example, the first and second ASICS 106A and 106B may be configured such that a value of the position signal generated by and output from the first ASIC 106A always has a value within a first range of values and a value of the position signal generated by and output from the second ASIC 106B always has a value within a second range of values, whereby the first range of values does not overlap with the second range of values. For example, an X position signal output from the first ASIC 106A may be weighted to a value between 0 and 7 and a value for an X position signal output from the second ASIC 106B may be a weighted value between 8 and 15, but the exemplary embodiments are not limited thereto.

According to various exemplary embodiments, each ASIC 106A and 106B may be configured to generate an X-axis position signal, a Y-axis position signal, an energy signal, and a timing signal. The combiner 108 may combine an X-axis position signal output from the first ASIC 106A and an X-axis position signal output from the second ASIC 106B to generate a combined X-axis position signal, and combine a Y-axis position signal output from the first ASIC 106A and a Y-axis position signal output from the second ASIC 106B to generate a combined Y-axis position signal. In these examples, a value of the X-axis position signal from the first ASIC 106A may be weighted interdependently with respect to a value of the X-axis position signal from the second ASIC 106B prior to being combined by the combiner 108 such that the X-axis signal from the first ASIC 106A has a value that does not overlap a value of the X-axis signal from the second ASIC 106B. Although not shown in FIG. 3, the imaging apparatus 300 may further include one or more TDCs that generate digitized timing information for the first ASIC 106A and the second ASIC 106B.

According to various exemplary embodiments, the scintillator array 102, SiPM detectors 104, ASICs 106, combiner 108, ADCs 110, and the FPGA 112 may be separate and distinct components from one another. Furthermore, the values of the position signals and the energy signal from the first ASIC 106A may be maintained despite being combined with position signals and an energy signal from the second ASIC 106B. As a result, the FPGA is capable of processing data from scintillator arrays 102A and 102B without an independent analog-to-digital converter for each scintillator array. Furthermore, although the example in FIG. 3 illustrates output signals from two ASICs being combined, it should be appreciated that more than two ASIC signals may be combined, for example, three ASICs, four ASICs, or more than four ASICs.

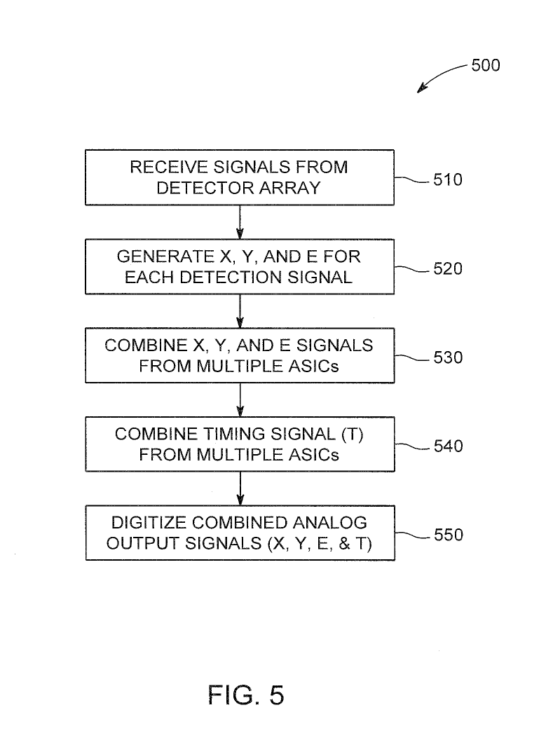

FIG. 5 illustrates a medical imaging method 500 in accordance with an exemplary embodiment. Referring to FIG. 5, in 510 electronic signals are received from a detector such as a photodetector array. The electronic signals may be based on gamma rays which have been detected from a patient, converted into photons by a scintillator, and converted into the electronic signal by a photodetector. In 520, an energy signal (E) and two position signals (X and Y) are generated. For example, in 510, the receiving may include a plurality of ASICs each receiving an electric signal from a respective detector, and generating, by each ASIC, a position signal (X and/or Y) and an energy signal based on the received electric signal.

In 530, at least one position signal and an energy signal from a first ASIC is respectively combined with at least one position signal and an energy signal from a second ASIC. For example, the signals from the detectors may be combined as shown in FIGS. 4A and 4B. As a result of the combining in 530, at least one combined position signal and a combined energy signal may be generated. In 540, a timing signal from the first ASIC is combined with a timing signal from a second ASIC to generate a combined timing signal. Finally, in 550 the combined position signal and the combined energy signal are converted into digitized image data for the first ASIC and the second ASIC based thereon.

For example, in 520 a value of the position signal generated by and output from the first ASIC may have a value that does not overlap a value of the position signal generated by and output from the second ASIC. Accordingly, when the values of the position signals are combined, they may still be discernable from one another. For example, the value of the position signal generated by and output from the first ASIC may always have a value within a first range of values and a value of the position signal generated by and output from the second ASIC may always have a value within a second range of values, and the first range of values may not overlap with the second range of values.

In the example of FIG. 5, each ASIC may generate an X-axis position signal and a Y-axis position signal in 520, and the combining in 530 may include combining an X-axis position signal output from the first ASIC and an X-axis position signal output from the second ASIC to generate a combined X-axis position signal, and combining a Y-axis position signal output from the first ASIC and a Y-axis position signal output from the second ASIC to generate a combined Y-axis position signal. In this example, a value of the X-axis position signal from the first ASIC may be weighted interdependently with respect to a value of the X-axis position signal from the second ASIC prior to the combining such that the X-axis signal from the first ASIC has a value that does not overlap a value of the X-axis signal from the second ASIC.

For each ASIC, the position (X,Y) and energy (E) signals may maintain their individual values after they've been combined/summed. For example, the ASICs may act as a summing network in which the energy and position signals are weighted according to the location of the scintillator array 102. For example, in FIG. 4B the weights in one direction run (1,1), (1,2), (1,3), (1,4), (3,1), (3,2), etc. In this example, the weights (3,1), (3,2), etc. may be applied to the weights as seen in FIG. 4A. Also, the detectors here are not required to be physically adjacent to each other, and the addition does not need to be programmed by a logic circuit.

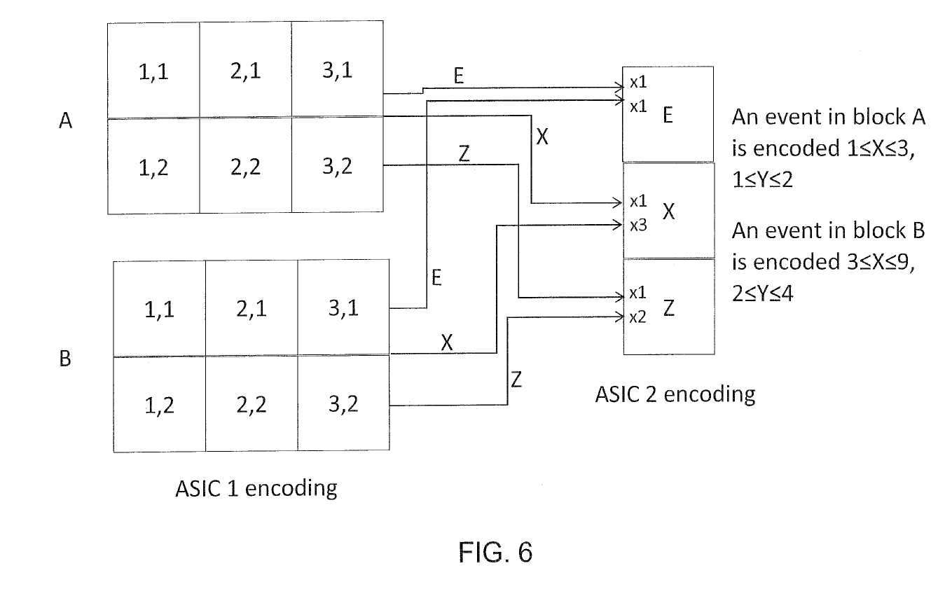

FIG. 6 illustrates an example of encoding ASIC output signals in accordance with an exemplary embodiment. Referring to FIG. 6, values (e.g., numbers, weights, and the like) may be scaled, encoded, or otherwise adjusted during the combining or prior to the combining. As a non-limiting example, the ASICs may be PSYCHE ASICS.

In FIG. 6, the position outputs are represented by X and Z and the energy output is represented by E. In this instance the weights on the first ASIC are identical between ASICs, but the second ASIC encodes the values by rescaling X and/or Z. Also, it would be fairly straightforward to feed in 4 different stage 1 ASICs and switch the X and Z weights between 1 and 2. As an example, the second ASIC may set the Z weights for the X values to 0 because each input may have an independent X and Z weight, however the design is not restricted to the PSYCHE ASIC. Also notice that the encoding at the first stage may be identical, but the weighting at the second stage allows for differentiation between the blocks. Accordingly, an event in block A may be encoded within a range of (1≦X≦3) and (1≦Z≦2) and an event in block B may be encoded within a range of (3≦X≦9) and (2≦Z≦4).

According to various exemplary embodiments, described herein is a system and method for summing ASIC outputs. The ASICs having outputs combined may be programmed such that calculated X position outputs and Y position outputs from each ASIC do not overlap with respect to the other. The two signals can then be combined either through a multiplexor, a summing amplifier, a simple wire, and the like, and an amount of digitizers for converting the ASIC signals into digital signals may be cut in half. This approach can extend to more ASICs as long as the calculated positions do not overlap with respect to one another.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. An imaging apparatus comprising:
a detector;
a plurality of application specific integrated circuits (ASICs), each ASIC configured to receive an electric signal from the detector and generate a position signal and an energy signal based on the received electric signal;
a combiner configured to combine a position signal output from a first ASIC and a position signal output from a second ASIC to generate a combined position signal, and combine an energy signal output from the first ASIC and an energy signal output from the second ASIC to generate a combined energy signal; and
a plurality of analog-to-digital converters (ADCs) comprising at least one ADC configured to receive the combined position signal and a second ADC configured to receive the combined energy signal, and generate digitized image data for the first ASIC and the second ASIC based on the combined position signal and the combined energy signal.

2. The imaging apparatus of claim 1, wherein the first and second ASICs are configured such that a value of the position signal generated by and output from the first ASIC has a value that does not overlap a value of the position signal generated by and output from the second ASIC.

3. The imaging apparatus of claim 1, wherein the first and second ASICS are configured such that a value of the position signal generated by and output from the first ASIC always has a value within a first range of values and a value of the position signal generated by and output from the second ASIC always has a value within a second range of values, and the first range of values does not overlap with the second range of values.

4. The imaging apparatus of claim 1, wherein each ASIC is configured to generate an X-axis position signal and a Y-axis position signal, and
the combiner is configured to combine an X-axis position signal output from the first ASIC and an X-axis position signal output from the second ASIC to generate a combined X-axis position signal, and combine a Y-axis position signal output from the first ASIC and a Y-axis position signal output from the second ASIC to generate a combined Y-axis position signal.

5. The imaging apparatus of claim 1, wherein a value of the X-axis position signal from the first ASIC is weighted interdependently with respect to a value of the X-axis position signal from the second ASIC prior to being combined by the combiner such that the X-axis signal from the first ASIC has a value that does not overlap a value of the X-axis signal from the second ASIC.

6. The imaging apparatus of claim 4, wherein the plurality of ADCs comprise three ADCs including a first ADC for receiving the combined X-axis position signal, a second ADC for receiving the combined Y-axis position signal, and a third ADC for receiving the combined energy signal.

7. The imaging apparatus of claim 1, wherein the combiner comprises a summing amplifier that receives outputs from the first and second ASICs.

8. The imaging apparatus of claim 1, further comprising a floating point gate array (FPGA) configured to receive the digitized image data from the ADC and process the digitized image data.

9. The imaging apparatus of claim 1, further comprising a time-to-digital converter (TDC) configured to generate digitized timing information for the first ASIC and the second ASIC.

10. The imaging apparatus of claim 1, wherein the detector comprises a silicon photomultiplier (SiPM) detector.

11. An imaging method comprising:
receiving, by a plurality of application specific integrated circuits (ASICs), an electric signal from a detector, and generating, by each ASIC, a position signal and an energy signal based on the received electric signal;
combining a position signal output from a first ASIC and a position signal output from a second ASIC to generate a combined position signal;
combining an energy signal output from the first ASIC and an energy signal output from the second ASIC to generate a combined energy signal; and
receiving the combined position signal and the combined energy signal and generating digitized image data for the first ASIC and the second ASIC based thereon.

12. The imaging method of claim 11, wherein the first and second ASICs are configured such that a value of the position signal generated by and output from the first ASIC has a value that does not overlap a value of the position signal generated by and output from the second ASIC.

13. The imaging method of claim 11, wherein the first and second ASICS are configured such that a value of the position signal generated by and output from the first ASIC always has a value within a first range of values and a value of the position signal generated by and output from the second ASIC always has a value within a second range of values, and the first range of values does not overlap with the second range of values.

14. The imaging method of claim 11, wherein each ASIC is configured to generate an X-axis position signal and a Y-axis position signal, and
the combining the position signal comprises combining an X-axis position signal output from the first ASIC and an X-axis position signal output from the second ASIC to generate a combined X-axis position signal, and combining a Y-axis position signal output from the first ASIC and a Y-axis position signal output from the second ASIC to generate a combined Y-axis position signal.

15. The imaging method of claim 11, wherein a value of the X-axis position signal from the first ASIC is weighted interdependently with respect to a value of the X-axis position signal from the second ASIC prior to the combining such that the X-axis signal from the first ASIC has a value that does not overlap a value of the X-axis signal from the second ASIC.

16. The imaging method of claim 11, wherein the combining of the position signals and the energy signals is performed by a summing amplifier that receives outputs from the first and second ASICs.

17. An imaging apparatus comprising:
a detector;
a plurality of application specific integrated circuits (ASICs), each ASIC configured to receive an electric signal from the detector and generate a position signal and an energy signal based on the received electric signal;
a combiner configured to combine a respective position signal generated by and output from four ASICs to generate one combined position signal, and combine a respective energy signal generated by and output from the four ASICs to generate a combined energy signal; and
an analog-to-digital converter (ADC) configured to receive the combined position signal and the combined energy signal and generate digitized image data for the four ASICs based thereon.
